(19) United States
(12) Patent Application Publication
(10) Pub. No.: US 2007/0259236 A1
(43) Pub. Date: Nov. 8, 2007

(54) Anionic fuel cells, hybrid fuel cells, and methods of fabrication thereof

(76) Inventors: Christopher M. Lang, Avondale Estates, GA (US); Paul A. Kohl, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/502,731

(22) Filed: Aug. 11, 2006

Related U.S. Application Data
(60) Provisional application No. 60/797,321, filed on May 3, 2006.

(51) Int. Cl. H01M 8/10; H01M 4/90; H01M 4/92; B05D 5/12; C25B 9/00

(52) U.S. Cl. 429/30; 429/40; 427/115; 204/263

(57) ABSTRACT

Anionic fuel cells, methods of fabrication thereof, CO₂ pumps, hybrid fuel cells, and methods for fabricating an anionic fuel cell, are disclosed.

### CLAIM OF PRIORITY TO RELATED APPLICATION

This application claims priority to co-pending U.S. provisional application entitled “NEAR ROOM TEMPERATURE CARBONATE FUEL CELL” having Ser. No. 60/797,321, filed on May 3, 2006, which is entirely incorporated herein by reference.

### STATEMENT REGARDING FEDERALLY SPONSORED RESEARCH OR DEVELOPMENT

The U.S. government may have a paid-up license in this invention(s) and the right in limited circumstances to require the patent owner to license others on reasonable terms as provided for by the terms of Grant No. 1906Z70 awarded by the Department of Energy of the U.S. Government.

### TECHNICAL FIELD

The present invention(s) is generally related to fuel cells, and, more particularly, is related to anionic fuel cells and methods of making anionic fuel cells.

### BACKGROUND

Portable electronic devices, including those for mobile communications, microsensors, micro-electromechanical systems (MEMS), and microfluidic devices benefit from advances in energy storage. The availability of power sources with higher energy density and lower cost enables a wider range of usage and functionality. One possible higher energy density source is the fuel cell.

For electronic devices with small power requirements, microfabricated power sources, including fuel cells, are being investigated. Issues to consider include reducing size and weight, improving signal integrity with fewer interconnects, increasing processing efficiency, and lowering cost.

Some fuels of interest in micro-fuel cells for devices include hydrogen, methanol, and other hydrocarbons (e.g., ethylene glycol or formic acid). Hydrogen fuel cells and direct methanol fuel cells (DMFCS) operate at relatively low temperature (e.g., ambient to 120° C.). They employ a solid proton exchange membrane (PEM) to transport the protons from the anode to the cathode. Hydrogen can be stored as a pressured gas or in a metal hydride form. It requires humidification for high membrane conductivity.

A methanol-water mixture can be oxidized at the anode in either liquid or vapor form. Methanol is an attractive fuel because it can be stored as a liquid, is inexpensive, and has a high specific energy. Compared with other fuel cell systems, the liquid-feed DMFC is relatively simple and could be easily miniaturized since it does not need a fuel reformer, complicated humidification, or thermal management system. Furthermore, methanol has a high energy density in comparison with lithium ion and lithium ion polymer batteries.

Proton exchange membranes can be used in low-temperature fuel cells that operate with either hydrogen or methanol. The solid membrane in conventional fuel cells is usually a perfluorinated polymer with sidechains terminating in sulfonic acid moieties, such as Nafion™. Membranes in PEM fuel cells generally contain water to keep the conductivity high. Methanol crossover causes a mixed potential and poisoning of the oxygen reduction reaction, leading to decreased performance. Therefore, there is a need in the industry to overcome at least some of the aforementioned inadequacies and deficiencies.

### SUMMARY

Briefly described, embodiments of this disclosure, among others, include anionic fuel cells, methods of fabrication thereof, CO₂ pumps, hybrid fuel cells, and methods for fabricating an anionic fuel cell. One exemplary an anionic fuel cell, among others, includes: an anionic membrane made of a material including a carbonate conducting electrolyte; a first catalyst layer disposed on a first side of the anionic membrane; and a second catalyst layer disposed on a cathode side of the anionic membrane.

One exemplary a CO₂ pump, among others, includes: an anionic membrane made of a material including a carbonate conducting electrolyte; a first catalyst layer disposed on a first side of the anionic membrane; a second catalyst layer disposed on a second side of the anionic membrane; a first current collector disposed on the first side of the anionic membrane and in contact with the first catalyst layer; and a second current collector disposed on the second side of the anionic membrane and in contact with the second catalyst layer.

One exemplary hybrid fuel cell, among others, includes: an anionic membrane made of a material including a carbonate conducting electrolyte; and a proton exchange membrane (PEM), wherein the anionic membrane is in electrical communication with PEM.

One exemplary method for fabricating a fuel cell, among others, includes: disposing a release layer onto a molding form; disposing a first porous catalyst layer onto the release layer; disposing a layer of an anionic membrane material onto the first porous catalyst layer; disposing a second porous catalyst layer onto the layer of the anionic membrane material; and disposing a second layer of an anionic membrane material onto the second porous catalyst layer.

Other structures, systems, methods, features, and advantages will be, or become, apparent to one with skill in the art upon examination of the following drawings and detailed description. It is intended that all such additional structures, systems, methods, features, and advantages be included within this description, be within the scope of the present disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of this disclosure. Moreover, in the drawings, like reference numerals designate corresponding parts throughout the several views.

FIG. 1 illustrates a cross-sectional view of a representative anionic fuel cell.

FIG. 2 illustrates a cross-sectional view of a representative anionic fuel cell.

FIG. 3 illustrates a cross-sectional view of a CO₂ pump utilizing a carbonate membrane.

FIG. 4 illustrates a hybrid fuel cell incorporating both an anionic fuel cell and a proton exchange membrane (PEM) fuel cell.

FIG. 5 illustrates outputs of an anionic fuel cell membrane and a PEM in relation to methanol fuel concentrations.

FIGS. 6A through 6C are sectional views that illustrate a representative method of fabricating an anionic fuel cell membrane.

FIGS. 7A through 7E are views that illustrate a representative method of fabricating an anionic fuel cell membrane.

FIGS. 8A and 8B are polarization and power curves, respectively, for an anionic fuel cell operating on hydrogen.

FIGS. 9A and 9B are polarization and power curves, respectively, for an anionic fuel cell operation on hydrogen when modified by ionic liquid.

FIG. 10 is a voltage curve of an anionic fuel cell operation on hydrogen after ceasing CO₂ flow.

FIG. 11 illustrates polarization and power curves for an anionic fuel cell operating on 1M methanol.

FIG. 12 illustrates polarization and power curves for an anionic fuel cell operating on pure methanol.

### DETAILED DESCRIPTION

In general, anionic fuel cells and methods of fabrication thereof are disclosed. In addition, hybrid fuel cell incorporating anionic membranes and methods of fabrication thereof are disclosed. The anionic fuel cells include an anionic membrane made of carbonate conducting electrolytes (e.g., carbonate salts, quaternary ammonium salts, phosphonium salts, and the like). Advantages of anionic fuel cells include the ability to operate at or near room temperature, the ability to utilize non-precious metals on at least the cathode side of the anionic fuel cell, and reduced or elevated electro-osmotic drag of fuel from one side of the fuel cell to the other side of the fuel cell. In contrast to other fuel cells, embodiments of the anionic fuel cell do not need extra storage space for water as the chemical reaction for the oxidation of methanol does not involve water as a reactant, as demonstrated by the following reaction: CH₃OH+3CO₃²→2H₂O+4CO₂+6e⁻.

The anionic membranes are relatively thin and have comparable area resistivities as thicker polymer membranes. The thinner the membrane, the easier it is for ions (e.g., CO₃²⁻ and/or HCO₃⁻) to move through it, thus increasing the amount of electrical current that can be generated. In addition, the anionic membranes can be fabricated using known micro-electronic fabrication techniques. In this regard, the anionic membrane can be fabricated onto the micro-electronic structure to which the fuel cell is going to be used.

In an embodiment, the anionic fuel cell can be directly integrated into an electronic device. For example, the anionic fuel cell can be integrated by placing the anionic fuel cell on the semiconductor chip, integrating the anionic fuel cell in the electronic package, chip-substrate, or printed circuit board, and interposing or attaching the anionic fuel cell to the chip as a separate part that is bonded to the chip.

In general, anionic fuel cells can be used in technology areas such as, but not limited to, microelectronics (e.g., microprocessor chips, communication chips, and optoeletronic chips), micro-electromechanical systems (MEMS), microfluidics, sensors, analytical devices (e.g., microchromatography), communication/positioning devices (e.g., beacons and GPS systems), recording devices, and the like.

The anionic fuel cell can actively and/or passively deliver fuel to the anionic membrane. For example, a pump or other delivery mechanism can be used to deliver a fuel to the anionic membrane. In another example, a fuel can be stored adjacent the anionic membrane. In the later embodiment, the fuel cell is sealed and non-flowing so that natural convection moves the fuel within the channel adjacent the anionic membrane. Also, combinations of these two embodiments can be used as well. In addition, the chemical by-products produced while using the fuel cell can be released through an open vent, in embodiments of an open fuel cell system, or through a permeable membrane, in embodiments of a closed fuel cell system. The chemical by-products may also be recycled within the fuel cell for use in subsequent fuel cell reactions.

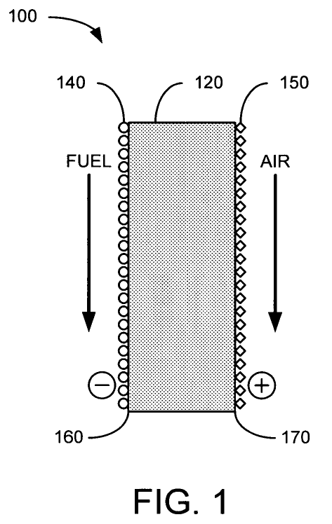

FIG. 1 illustrates a cross-sectional view of a representative anionic fuel cell 100. The anionic fuel cell 100 includes an anionic membrane 120 and catalyst layers 140 and 150 disposed on each side of the anionic membrane 120. As depicted in FIG. 1, a fuel (e.g., H₂, methanol, formic acid, ethylene glycol, ethanol, and combinations thereof) is contacted with one side of the anionic membrane 120 (e.g., on the anode (−) side 160 of the membrane), while a gas including CO₂ and O₂ (e.g., air) is contacted on the opposite side of the anionic membrane 120 (e.g., on the cathode (+) side 170 of the membrane). In addition, there is an electrically conductive path between the catalyst layer 140 and an anode current collector (not shown). Similarly, an electrically conductive path exists between the catalyst layer 150 and a cathode current collector (not shown).

The anionic membrane 120 can include materials such as, but not limited to, carbonate conducting electrolytes. The anionic membrane 120 can be made of materials such as, but not limited to, solids, liquids, gels, sol-gels, or combinations thereof. The use of liquid, gel, or sol-gel membrane materials may expedite the reaction rate by reducing the interface energy barrier between the solids and gas. A permeable barrier can be used to keep the liquid, gel, or sol-gel membrane materials in place while allowing migration of ions. Barrier materials can include, but are not limited to, polymers, ion conductive solids, porous glasses, porous crystalline materials, and combinations thereof.

The carbonate conducting electrolytes can include, but are not limited to, carbonate salts, quaternary ammonium salts, alkali carbonates, polymer-based carbonates, phosphonium salts, and combinations thereof. Carbonate salts can include, but are not limited to, bismuth carbonate, copper carbonate, iron carbonate, lead carbonate, nickel carbonate, and combinations thereof. Quaternary ammonium salts can include, but are not limited to, tetrabutyl ammonium carbonate, tributylmethylammonium carbonate, triethylmethylammonium carbonate, and combinations thereof. Alkali carbonates can include, but are not limited to, lithium carbonate, sodium carbonate, potassium carbonate carbonate, and combinations thereof. Polymer-based carbonates can include, but are not limited to, polypropylene carbonate, quaternary ammonium-functionalized styrene, phosphonium-functionalized polymers, and combinations thereof. In addition, the membrane layer 120 can include material such as compounds that do not dissolve in fuels (e.g., polydimethysiloxane, fluorocarbons, polyethylene, polypropylene, and combinations thereof).

The anionic membrane 120 has a thickness of less than about 500 micrometers (μm), about 0.01 to 10 μm, about 0.1 to 5 μm, about 0.1 to 2 μm, about 0.5 to 1.5 μm, and about 1 μm. The length of the membrane layer 120 can be from about 0.001 m to 100 m, and the width can be the same. It should be noted that the length and width are dependent on the application and can be adjusted accordingly. The geometry of the membrane can include, but is not limited to, square, rectangular, cylindrical, polygonal, combinations thereof, and the like.

The anionic membrane 120 has an area resistivity of about 0.1 to 3000 ohms cm², about 0.1 to 100 ohms cm², about 0.1 to 10 ohms cm², about 1 to 100 ohms cm², and about 1 to 10 ohms cm². The area resistivity is defined as the resistivity across the area of the membrane exposed to the fuel (e.g., resistance times area or resistivity times thickness).

The anionic membrane 120 can be formed using methods such as, but not limited to, spin-coating, plasma enhanced chemical vapor deposition (PECVD), screen printing, doctor blading, spray coating, roller coating, meniscus coating, and combinations thereof.

The catalyst layers 140 and 150 can include a catalyst such as, but not limited to, aluminum, cobalt, copper, iron, manganese, nickel, platinum, platinum/ruthenium, palladium, alloys of each, and combinations thereof. The catalyst layers 140 and 150 can include the same catalyst or different catalysts. Precious metal catalysts (e.g., platinum) may be used at the anode side 160 of the membrane layer 120 (i.e., catalyst layer 140). In general, anionic fuel cells can use non-precious metal catalysts (e.g., nickel) at the cathode side 170 of the membrane layer 120 (i.e., catalyst layer 150). Non-precious metal catalysts may also be used at the anode side 160 of the membrane layer 120 (i.e., catalyst layer 140).

The catalyst layers 140 and 150 are typically porous catalyst layers that allow carbonate ions to pass through the layer. In some embodiments, among others, the catalyst is disposed upon a mesh made from, but not limited to, carbon, metal, polymers, porous glass, and combinations thereof. The catalyst layers 140 and 150 can have a thickness of less than 1 μm, about 0.01 to 100 μm, about 0.1 to 5 μm, and about 0.3 to 1 μm.

The catalyst layers 140 and 150 can include alternative layering of catalyst and the membrane material, which builds thicker catalyst layers 140 and 150 (e.g., two or more layers). For example, two layers may improve the oxidation rate of the fuel. This is advantageous because it can increase the anode catalyst loading and keep the catalyst layer porous. The high surface area may allow a high rate of oxidation of the fuel. A higher rate corresponds to higher electrical current and power.

The anionic membrane can be further processed by post-doping. The dopants can be diffused or implanted into the membrane to increase the ionic conductivity. The dopants can include, but are not limited to, boron and phosphorous. Each dopant can be individually diffused into the anionic membrane from a liquid or from a solid source, or can be ion-implanted using a high voltage ion accelerator.

Fuel cells operate over a wide range of temperatures. High temperature cells, such as traditional molten anionic fuel cells can operate at temperatures in the range of 650° C. or greater. In contrast, anionic fuel cells operate in a temperature range of about −100 to +200° C., about −50 to +80° C., about 0 to +80° C., about +10 to +80° C., about +20 to +50° C., about +20 to +40° C., and about +20 to +30° C. For example, the fuel cell may be operated over the liquid range of methanol, −98° C. to 65° C. and the liquid range of methanol-water mixtures, −98° C. to 100° C.

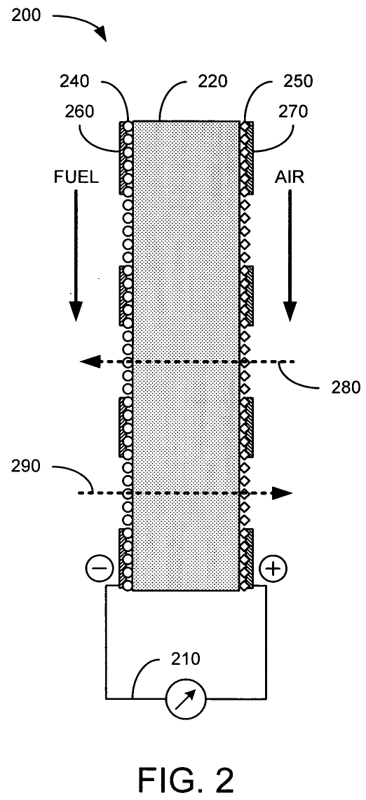

FIG. 2 illustrates a cross-sectional view of a representative anionic fuel cell. The anionic fuel cell 200 includes an anionic membrane 220 and catalyst layers 240 and 250 disposed on the anode (−) and cathode (+) sides of the anionic membrane 220, respectively. In an embodiment, among others, a gas containing carbon dioxide (CO₂) (e.g., air) is supplied to the cathode side of the anionic membrane 220 of the anionic fuel cell 200. The oxygen and CO₂ in the air are reduced to form carbonate ions (CO₃²⁻ and/or HCO₃⁻) as indicated by the following reaction: 2CO₂+O₂+4e⁻→2CO₃²⁻. Increasing the concentration of carbon dioxide provided in the air supply may increase the reaction rate and fuel efficiency of the anionic fuel cell. The carbonate ions (CO₃²⁻ and/or HCO₃⁻) formed by the reaction migrate across the membrane 220 from the cathode to the anode as indicated by arrow 280.

Fuel is supplied to the anode side of the anionic membrane 220. Fuels can include, but are not limited to, H₂, methanol, formic acid, ethylene glycol, ethanol, and combinations thereof. In an embodiment, among others, pure methanol is utilized because of its high energy density and low molecular weight. In other embodiments, methanol can be mixed with water to reduce the concentration to less than about 24.8 M, which is the concentration of pure methanol at 15° C. In a proton exchange membrane fuel cell, at least one water molecule is necessary for every methanol molecule oxidized. The concentration of 50 mole percent methanol solution at 15° C. is 17.6 M. In addition to the high energy density, pure methanol has the advantage of simplifying the fuel delivery system by not having added components for holding, delivering, and/or mixing water.

At the anode of an embodiment, the carbonate ions oxidize methanol, supplied as the fuel, to form water and CO₂ as indicated by the following equation: CH₃OH+3CO₃²⁻→2H₂O+4CO₂+6e⁻. A portion of the carbon dioxide produced at the anode may migrate across the anionic membrane 220 to the cathode as indicated by arrow 290. The CO₂ increases the concentration at the cathode for reduction to ionized carbonate. Electrons produced at the anode (−) of the fuel cell 200 are collected by the anode current collector 260 and flows through the electrical circuit 210 to the cathode (+) of the anionic fuel cell 200 via the cathode current collector 270.

In the current embodiment, the anode current collector 260 collects and/or emits electrons through the first porous catalyst layer 240. In other embodiments, the anode current collector 260 collects and/or emits electrons through the first porous catalyst layer 240. The anode current collector 260 can be made of a material such as, but is not limited to, platinum, gold, silver, palladium, aluminum, nickel, carbon, alloys of each, and combinations thereof.

In the current embodiment, the cathode current collector 270 emits electrons. In other embodiments, the cathode current collector 270 emits and/or collects electrons. The cathode current collector 270 can be made of a material such as, but is not limited to, platinum, gold, silver, palladium, aluminum, nickel, carbon, alloys of each, and combinations thereof.

The various anode current collectors 260 and cathode current collectors 270 can be electronically connected in series or parallel, depending on the configuration desired (e.g., the wiring could be from anode-to-cathode (in series) or anode-to-anode (in parallel)). In an embodiment, the anionic fuel cells can be connected electronically in series to form fuel cell stacks to increase the output voltage. In another embodiment, the connections can be made in parallel to increase the output current at the rated voltage.

Making the fuel conductive to ions can increase the anode surface area and allow increased current densities. Conductivity of the fuel can be increased by adding compounds such as, but not limited to, sodium carbonate, potassium carbonate, quaternary ammonium carbonate, and combinations thereof. Higher currents are allowed without adding more metal to the surface of the catalyst layer 240. Removing excess metal from the surface of the catalyst layer 240 allows for greater surface area to be utilized for ion collection. In addition, use of non-precious catalysts can be promoted, thereby reducing the cost of the system.

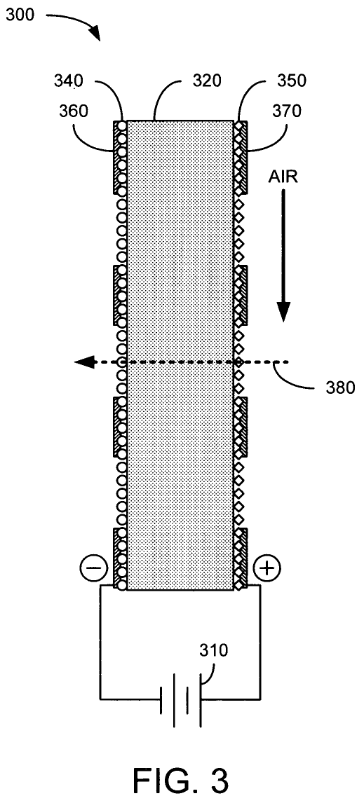

FIG. 3 illustrates a cross-sectional view of a CO₂ pump 300 utilizing a carbonate membrane. The CO₂ pump 300 includes an anionic membrane layer 320 similar to the anionic membrane layer 220 used in an anionic fuel cell 200. The CO₂ pump 300 also includes catalyst layers (340 and 350) and current collectors (360 and 370) similar to those utilized in an anionic fuel cell 200. In an embodiment, among others, a power supply 310 is connected to a CO₂ pump 300. The power supply 310 provides the driving force for operation of the CO₂ pump 300. The CO₂ pump 300 can be used in systems that establish an artificial air environment that contains or supports carbon dioxide producing organisms or systems, such as environmental cleanrooms, space travel, and submarines.

Air containing carbon dioxide (CO₂) is supplied to the cathode (+) side of the CO₂ pump 300. The oxygen and CO₂ in the air are reduced to form carbonate ions (CO₃²⁻) as indicated by the following reaction: 2CO₂+O₂+4e⁻→2CO₃²⁻. The carbonate ions formed by the reaction migrate across the anionic membrane 320 from the cathode to the anode of the CO₂ pump 300 as indicated by arrow 380.

When the carbonate ions reaches the anode, the reaction is reversed as indicated by the following reaction: CO₃²⁻→CO₂+½O₂+2e⁻. The CO₂ can then be discharged as concentrated by-product stream.

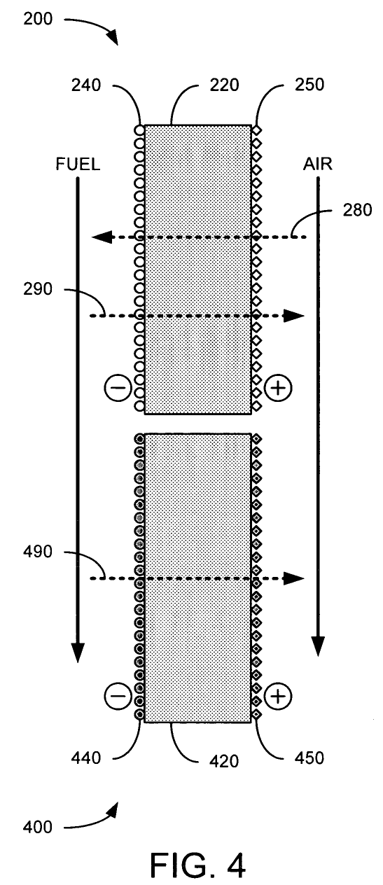

FIG. 4 illustrates a hybrid fuel cell incorporating both an anionic fuel cell and a proton exchange membrane (PEM) fuel cell. The anionic fuel cell 200 includes an anionic membrane 220 and catalyst layers 240 and 250 disposed on the anode (−) and cathode (+) sides of the anionic membrane 220, respectively. In an embodiment, among others, air containing carbon dioxide (CO₂) is supplied to the cathode side of the anionic membrane 220 of the anionic fuel cell. The oxygen and CO₂ in the air are reduced to form ionized carbonate (CO₃²⁻) as indicated by the following reaction: 2CO₂+O₂+4e⁻→2CO₃²⁻. The carbonate ions formed by the reaction migrate across the anionic membrane 220 from the cathode to the anode as indicated by arrow 280.

In an embodiment, fuel is supplied to the anode side of the fuel cell 200. Fuels can include, but are not limited to, H₂, methanol, formic acid, ethylene glycol, ethanol, and combinations thereof At the anode of the non-limiting embodiment, the carbonate ions oxidize methanol, supplied as the fuel, to form water and CO₂ as indicated by CH₃OH+3CO₃²⁻→2H₂O+4CO₂+6e⁻. The carbon dioxide produced at the anode may migrate across the anionic membrane 220 to the cathode as indicated by arrow 290. The recycled CO₂ increases the concentration at the cathode for reduction to carbonate ions. Water formed by the reaction mixes with the fuel and migrates toward the PEM fuel cell 400.

The PEM fuel cell 400 includes a membrane layer 420 and a catalyst layer 440 and 450 disposed on each side of the membrane 420. As depicted in FIG. 4, the fuel is contacted with one side of the PEM fuel cell 400 (e.g., on the anode (−) side of the membrane), while air is contacted on the opposite side of the PEM fuel cell 400 (e.g., on the cathode (+) side of the membrane).

The membrane layer 420 can include materials such as, but not limited to, organic conducting materials and inorganic conducting materials. For example, the membrane can include material such as, but not limited to, silicon dioxide, doped silicon dioxide, silicon nitride, doped silicon nitride, silicon oxynitride, doped silicon oxynitride, metal oxides (e.g., titanium oxide, tungsten oxide), metal nitrides (e.g., titanium nitride), doped metal oxides, metal oxynitirdes (e.g., titanium oxynitride), doped metal oxynitrides, and combinations thereof. In general, the membranes can be doped with about 0.1 to 20% of dopant in the membrane and about 0.1 to 5% of dopant in the membrane.

The doped silicon dioxide can include, but is not limited to, phosphorous doped silicon dioxide, boron doped silicon dioxide, aluminum doped silicon dioxide, arsenic doped silicon dioxide, and combinations thereof. In general, the doping causes atomic scale defects such as M-OH (M is a metal) and distort the lattice so that protons can be transported there through. The amount of doping can be from 0.1 to 20% by weight of dopant in membrane, 0.5 to 10% by weight of dopant in membrane, and 2 to 5% by weight of dopant in membrane.

The membrane layer 420 has a thickness of less than about 10 micrometers (μm), about 0.01 to 10 μm, about 0.1 to 5 μm, about 0.1 to 2 μm, about 0.5 to 1.5 μm, and about 1 μm. The length of the membrane layer 420 can be from about 0.001 m to 100 m, and the width can be from about 1 μm to 1000 μm. It should be noted that the length and width are dependent on the application and can be adjusted accordingly.

The membrane layer 420 has an area resistivity of about 0.1 to 3000 ohms cm², about 0.1 to 100 ohms cm², about 0.1 to 10 ohms cm², about 1 to 100 ohms cm², and about 1 to 10 ohms cm². The area resistivity is defined as the resistivity across the area of the membrane exposed to the fuel (e.g., resistance times area or resistivity times thickness).

The membrane layer 420 can be formed using methods such as, but not limited to, spin-coating, plasma enhanced chemical vapor deposition (PECVD), screen printing, doctor blading, spray coating, roller coating, meniscus coating, and combinations thereof.

The catalyst layers 440 and 450 can include a catalyst such as, but not limited to, platinum, platinum/ruthenium, nickel, palladium, alloys of each, and combinations thereof. In general, in an embodiment a platinum catalyst is used when the fuel is hydrogen and in another embodiment a platinum/ruthenium catalyst is used when the fuel is methanol. The catalyst layers 440 and 450 can include the same catalyst or a different catalyst. The catalyst layers 440 and 450 is typically a porous catalyst layer that allows protons to pass through the porous catalyst layer. In addition, there is an electrically conductive path between the catalyst layer and the anode current collector.

The catalyst layers 440 and 450 can have a thickness of less than about 1 mm, about 0.01 to 100 μm, about 0.1 to 5 μm, and about 0.3 to 1 μm.

The catalyst layers 440 and 450 can include alternative layering of catalyst and the membrane material, which builds a thicker catalyst layer 440 and 450 (e.g., two or more layers). For example, two-layers improve the oxidation rate of the fuel. This is advantageous because it can increase the anode catalyst loading and keep the catalyst layer porous. The high surface area will allow a high rate of oxidation of the fuel. A higher rate corresponds to higher electrical current and power.

The membrane can be further processed by post-doping. The dopants can be diffused or implanted into the membrane to increase the ionic conductivity. The dopants can include, but are not limited to, boron and phosphorous. Each dopant can be individually diffused into the membrane from a liquid or from a solid source, or can be ion implanted using a high voltage ion accelerator. The conductivity of the membrane can be increased by diffusion of acidic compounds (e.g., carboxylic acids (in the form of acetic acid and trifluoracetic acid) and inorganic acids such as phosphoric acid and sulfuric acid) into the membrane.

In an embodiment, among others, the fuel of methanol mixed with water is supplied to the anode side of the PEM fuel cell 400. At the anode of the non-limiting embodiment, the methanol supplied as fuel and the water created at the anionic fuel cell membrane 200 react as indicated by CH₃OH+H₂O→CO₂+6H⁺+6e⁻. The hydrogen ions (H⁺) produced at the anode may migrate across the membrane 400 to the cathode as indicated by arrow 490. The transported proton (H⁺) reacts with oxygen in the air to form water as indicated by 3/2O₂+6H⁺+6e⁻→3H₂O. The carbon dioxide produced at the anode of the PEM 400 can be recycled by migrating to the cathode of the anionic fuel cell membrane 200 as indicated by arrow 290.

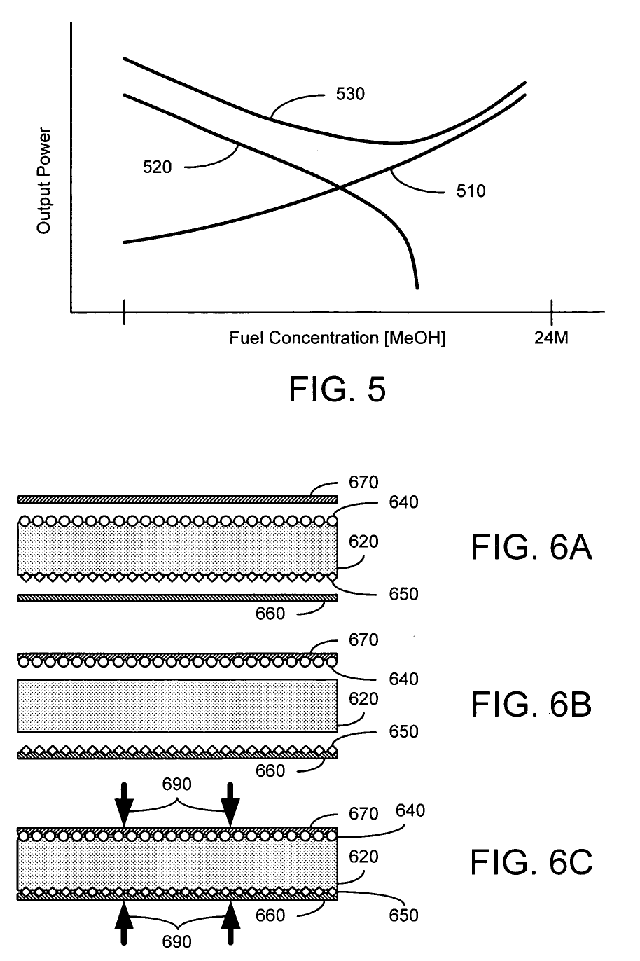

A hybrid combination of anionic fuel cell and proton fuel cell provides at least one advantage in that, as the efficiency of the anionic fuel cell decreases with water production at the anode, the efficiency of the proton fuel cell increases because of the added water. FIG. 5 illustrates the outputs of an anionic membrane and a PEM in relation to methanol fuel concentrations. Anionic fuel cells operate with methanol concentrations up to about 25 moles per liter (M) (pure methanol), about 1 to 25 M, about 1 to 10 M, about 10 to 25 M, and about 17 to 25 M. PEMs operate with methanol concentrations in ranges of less than about 14 M, about 1 to 14 M, and/or about 1 to 10 M.

A high concentration of methanol also allows operation at lower temperatures. The freezing point of 19 M methanol is about −156° F.

As illustrated in FIG. 5, the power generated by an anionic fuel cell (curve 510) increases as the concentration of methanol increases. In contrast, because of the need for water to supply the reaction, the power generated by a proton fuel cell (curve 520) is high with a low methanol concentration and decreases as the purity increases. The combination of anionic fuel cells and proton fuel cells allows for a more constant power generation over a wider range of fuel concentrations (curve 530) than can be provided by an individual membrane (curves 510 and 520).

Now having described the structure of anionic fuel cells in general, the following describes exemplar embodiments for fabricating an anionic fuel cell. FIGS. 6A through 6C are sectional views that illustrate a representative method of fabricating an anionic fuel cell. It should be noted that for clarity, some portions of the fabrication process are not included in FIGS. 6A through 6C. As such, the following fabrication process is not intended to be an exhaustive list that includes all steps required for fabricating an anionic fuel cell. In addition, the fabrication process is flexible because the process steps may be performed in a different order than the order illustrated in FIGS. 6A through 6C, or some steps may be performed simultaneously.

FIG. 6A illustrates an anionic membrane 620 of an anionic fuel cell membrane. In an embodiment, among others, the anionic membrane 620 can be a commercially available anion exchange membrane (Cl⁻ or OH⁻ form) appropriately sized for the application. The anionic membrane 620 is prepared by soaking in a chemical solution such as, but not limited to, 0.5 M Na₂CO₃ and 0.5 M NaHCO₃, or other carbonate solutions. The solution only needs to contain lithium, sodium, potassium, and the like carbonate and/or bicarbonate. The current permeation is necessary to prevent complete damage of the membrane. Very dilute or concentrative solutions could be used, but will effect time for equilibrium and stability of the membrane. The membrane layer 620 can be soaked for periods of less than about one hour, about one day, about three days, about one week, about 2 weeks, or about one month.

In addition, FIG. 6A illustrates the anionic membrane with first and second porous catalyst layers 640 and 650, respectively, disposed on each side the membrane layer 620. The catalyst layers 640 and 650 can include a catalyst such as, but not limited to, nickel, platinum, platinum/ruthenium, palladium, alloys of each, and combinations thereof. The porous catalyst layers 640 and 650 can be formed by sputtering, evaporation, spraying, painting, chemical vapor deposition, and combinations thereof. In some embodiments, among others, the catalyst is disposed upon a mesh made from, but not limited to, carbon, polymers, metals, and combinations thereof.

FIG. 6A further illustrates current collectors 660 and 670 that are disposed adjacent to the catalyst layers 640 and 650, respectively. The current collectors can include, but is not limited to, platinum, gold, silver, palladium, aluminum, nickel, carbon, alloys of each, and combinations thereof.

In some embodiments, the current collectors 660 and 670 can also operate as a mesh for the catalyst layers 640 and 650. FIG. 6B illustrates the catalyst layers 640 and 650 disposed on the current collectors 660 and 670, respectively. For example, in an embodiment, platinized carbon paper can be utilized to provide both the catalyst layer and the current collector.

As illustrated in FIG. 6C, the anionic membrane 620, catalyst layers 640 and 650, and current collectors 660 and 670 can be formed into a single unit through hot pressing as indicated by arrows 690. Methods of forming anionic fuel cell membranes include dip coating, hot pressing, spin coating, and combinations thereof. The polymer membrane can be polymerized in-situ. Polymerization of the polymer or crosslinking of a thermoplastic polymer can be accomplished by many means, including chemical initiation, electromagnetic irradiation, or ion bombardment. Hot pressing can be performed in a temperature range of about 0 to +500° C., about +50 to +400° C., about +100 to +300° C., about +200 to +300° C., and about +250 to +300° C. Pressure can be applied in a range of about +500 to +3000 psi, about +1000 to +2000 psi, about +1200 to +1500 psi, and about +1200 to +1250 psi. Hot pressing can range from less than about 12 hours, less than about 1 hour, less than about 30 minutes, about 5 to 30 minutes, and about 5 to 10 minutes.

In one non-limiting method of fabricating an anionic membrane, among others, platinized carbon paper, comprising a catalyst layer and a current collector as illustrated in FIG. 6B, is placed on each side of a prepared membrane. The layers are hot pressed at 300° C. and 1200 psi for five minutes to form a complete anionic fuel cell membrane.

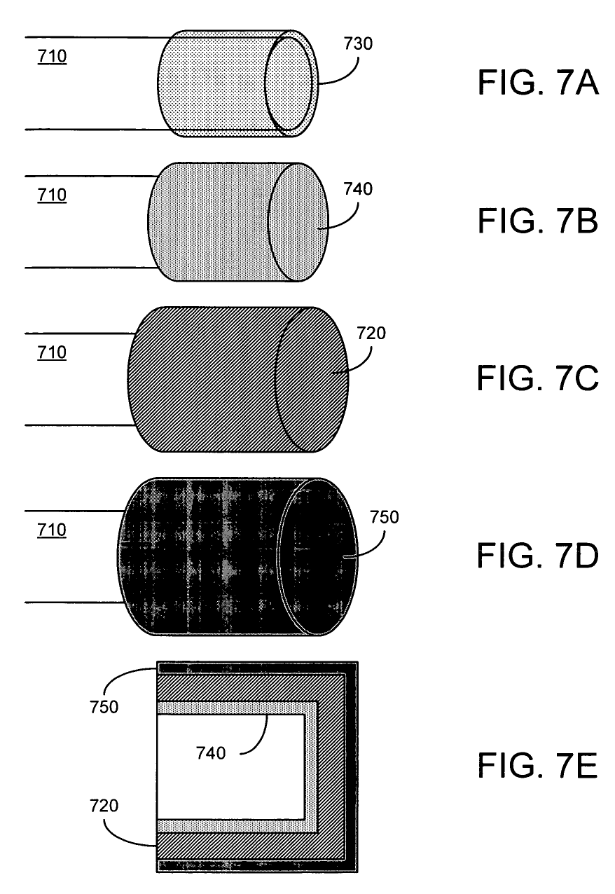

FIGS. 7A through 7E are views that illustrate a representative method of fabricating an anionic membrane. It should be noted that for clarity, some portions of the fabrication process are not included in FIGS. 7A through 7E. As such, the following fabrication process is not intended to be an exhaustive list that includes all steps required for fabricating an anionic fuel cell. In addition, the fabrication process is flexible because the process steps may be performed in a different order than the order illustrated in FIGS. 7A through 7E, or some steps may be performed simultaneously.

FIG. 7A illustrates a glass fiber 710 that is used as a molding form for an anionic fuel cell. In the current embodiment, the glass fiber is used to produce a cylindrical geometry. It should be understood that utilizing other molding forms and methods could produce variations in the cell fuel geometry. A release layer 730 is disposed upon the glass fiber 710 in preparation for forming the fuel cell. The release layer can be selected from, but not limited to, one of the following: polypropolyene carbonate, polyethylene carbonate, polycyclohexene carbonate, and polynorbomene carbonate, and combinations thereof. The release layer 730 can be applied using methods including, but not limited to, dip coating, spraying, and vapor deposition.

The anode of the fuel cell is disposed on the glass fiber 710 and release layer 730 as illustrated in FIG. 7B. Disposition of the anode can include disposing of a current collector, disposing of a catalyst layer, and/or combinations thereof. Disposition methods can include, but are not limited to, dip coating, spraying, and vapor deposition, and combinations thereof. In an embodiment, FIG. 7B illustrates the disposition of an anode layer 740.

The membrane of the fuel cell is then disposed on anode of the fuel cell as illustrated in FIG. 7C. Disposition of the membrane can include the disposing of one or more membrane layers. Disposition methods can include, but are not limited to, dip coating, doctor blading, spincoating, spraying, vapor deposition, and combinations thereof. FIG. 7C illustrates the disposition of a membrane layer 740.

The cathode of the fuel cell is disposed on the membrane as illustrated in FIG. 7D. Disposition of the anode can include disposing of a catalyst layer, disposing of a current collector, and/or combinations thereof. Disposition methods can include, but are not limited to, hot pressing, dip coating, doctor blading, spincoating, spraying, and combinations thereof. In an embodiment, FIG. 7D illustrates the disposition of a cathode layer 750.

The fuel cell is then removed from the glass fiber 710 or other molding form. A cross section of a fuel cell, including the membrane layer 720 and the catalyst layers 740 and 750, is illustrated in FIG. 7E. Other embodiments may include current collectors (not shown in FIG. 7E). It should be understood that location of the anode and cathode can be interchanged depending upon design, manufacturing, and application.

### EXAMPLE

Now having described the embodiments of the fuel cells in general, Example 1 describes some embodiments of the fuel cells and uses thereof. The following is a non-limiting illustrative example of an embodiment of the present disclosure that is not intended to limit the scope of any embodiment of the present disclosure, but rather is intended to provide some experimental conditions and results. Therefore, one skilled in the art would understand that many experimental conditions can be modified, but it is intended that these modifications be within the scope of the embodiments of the present disclosure.

Fuel cells have several potential advantages over other energy conversion and storage devices. High temperature cells, such as solid oxide fuel cells have high power and energy conversion efficiency. Low temperature fuel cells (i.e. near room-temperature), such as proton exchange membrane (PEM) fuel cells, can be more convenient to use; however, the power and conversion efficiency are lower because of kinetic limitations. PEM cells using liquid fuels, such as methanol or formic acid, can have high energy density compared to batteries, if concentrated liquid fuels can be used. Dilute methanol or formic acid can often be used to increase the power density at the expense of energy density.

PEM cells use a polymeric membrane to transport protons from the anode to the cathode, converting the fuel (e.g. hydrogen, methanol, formic acid) and oxygen into water. The half reaction for the oxidation of methanol and water can be indicated by CH₃OH+H₂O→CO₂+6H⁺+6e⁻.

Expensive, precious metal catalysts, such as platinum, may be required at the cathode due to the production of hydrogen peroxide under acidic conditions. Alkaline fuel cells can use non-precious metal catalysts (e.g. nickel) due to a more facile mechanism for oxygen reduction and the higher operating temperature. However, alkaline cells with hydroxide electrolytes may be intolerant to air because of the formation and precipitation of carbonate salts. Molten carbonate cells are tolerant to carbon dioxide and can be operated in air, although their operating temperature and liquid electrolyte can be technologically challenging to deal with.

Small fuel cells, where high energy density and convenience are at a premium, are generally operated at ambient temperature with little or no auxiliary hardware (such as pumps or water recycling equipment) because of the lack of insulation and need for low cost. One advantage of low power fuel cells, such as for use in low power wireless sensors, is the ability to store and use highly concentrated fuels in the smallest possible form factor.

In this embodiment, the feasibility of a room temperature carbonate (RTC) fuel cell system was examined. A RTC cell offers carbon monoxide tolerance, as well as the potential to use non-precious metal catalysts (e.g. nickel), especially at the air cathode. Another advantage of the carbonate cycle is that, when methanol is used as the fuel at the anode, water is not necessary to oxidize methanol (as in PEM cells). Thus, the anode does not consume water and allowing water to be eliminated from the fuel, which would significantly increase the energy density of the fuel. The proposed half reaction for an ambient temperature carbonate conducting fuel cell using methanol as the fuel can be indicated as CH₃OH+3CO₃²⁻→2H₂O+4CO₂+6e⁻. Anionic fuel cells recycle the carbon dioxide produced at the anode to the cathode, as indicated by 2CO₂+O₂+4e⁻→2CO₃²⁻, so as to increase its concentration and the fuel efficiency.

In this embodiment, a carbonate conducting electrolyte based on an anion exchange membrane was used. The pH sensitivity of the membrane was addressed by converting it to the bicarbonate/carbonate form. The resistivity of the membranes was measured and chemical stability in methanol evaluated. Hydrogen, 1M methanol, and pure methanol have been considered. Carbon dioxide was observed at the anode exhaust when operating on hydrogen.

### EXAMPLES

Calcium hydroxide (>99.5%, Fisher Scientific) and methanol (99.9%, Fisher Scientific) were used as-received or diluted with de-ionized (DI) water. 1-butyl-3-methylimidazolium tetrafluoroborate (BMIBF₄, >97%, Fluka) was used as received. Carbon dioxide, hydrogen, oxygen, and nitrogen gases were obtained from Air Products. Carbonate anion exchange membranes were prepared by soaking chloride containing AFN anion exchange membranes (AFN, Somerset, N.J.) in aqueous solutions of sodium bicarbonate (>99.9%, Fisher Scientific) and sodium carbonate (>99.5%, EMD Chemicals). Upon soaking in 1M sodium carbonate, the membranes darkened from a light brown to near black and were found to be unusable as carbonate exchange membranes due to the high pH. The aqueous solution also changed from clear to yellow. In an attempt to prevent damage to the membranes, sodium bicarbonate was added to lower the pH of the solution (resulting in green transparent membranes).

Fuel cells were constructed in two ways. The cells used for the hydrogen tests were formed by sandwiching the carbonate anion exchange membrane between two carbon electrodes coated on one side with platinum (20 wt % Pt/Vulcan XC-72 [1 mg/cm² Pt], ElectroChem, Inc.) and hot-pressed together. The cells used in the methanol tests were constructed using epoxy to attach a rubber gasket (with a hole of known area punched out) to the electrode and membrane. An EG&G Princeton Applied Research model 263A potentiostat was used for the electrochemical measurements.

### Results and Discussion

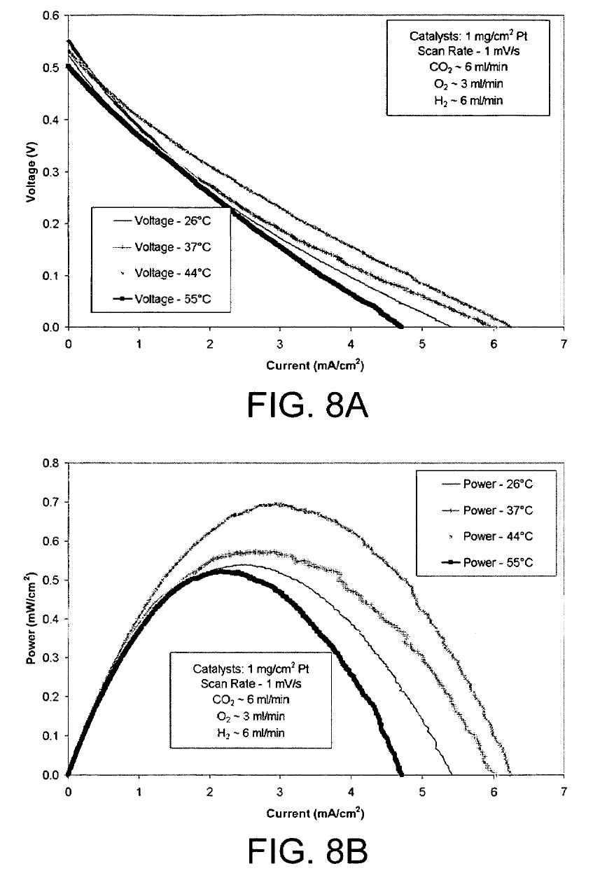

Hydrogen provides the more facile electrochemical fuel for testing the operation of the anionic fuel cell and was first used in the anode compartment. Carbon dioxide and oxygen, roughly 2-to-1 ratio, were used as the feed to the cathode. FIGS. 8A and 8B illustrate polarization and power curves, respectively, for an exemplary cell operated at four temperatures. The maximum power and current increased from 0.54 mW/cm² and 5.4 mA/cm² to 0.68 mW/cm² and 6.2 mA/cm², as the temperature increased from 26 to 44° C. However, when the temperature was increased to 55° C. the performance deteriorated significantly with the maximum current, 4.8 mA/cm², falling below that measured at 26° C. When discharged across a 74.4 ohm resistor, a stable 0.3 V (±2 mV) was measured for more than 6.5 hours, after which the testing was terminated.

The performance drop at 55° C. may be due to drying of the polymer membrane. The effect of humidification was tested by soaking two membranes in the same 0.5 M sodium bicarbonate/0.5 M sodium carbonate (0.5B/0.5C) solution. One membrane was then removed from the solution and used while the other was dried under vacuum at ambient temperature for 18 hours. The resistivity of each membrane was measured in a 0.5B/0.5C solution. The “area resistivity” of the dried membrane was found to be 101.4 ohm-cm², which was nearly three times higher than the measured 36.2 ohm-cm² for the membrane that was not dried. Membranes can swell when exposed to moisture resulting in an increase in conductivity. The dried membrane was then resoaked in a 0.5B/0.5C solution for 48 hours. After soaking, the area resistivity dropped below 5 ohm-cm². This reduction in resistivity may be due to swelling of the membranes on wetting. Also, upon drying, the membrane may contract and pull away from the Pt on the carbon electrode resulting in poorer interfacial contact between the electrode and membrane, reducing the performance of the system.

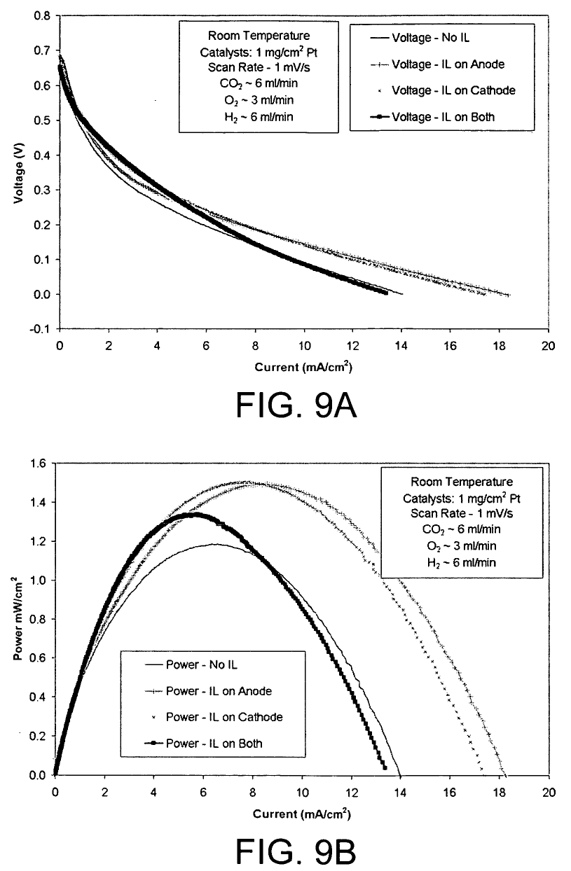

In an attempt to retain moisture in the membrane, a new fuel cell was constructed and characterized. BMIBF₄, a hydrophobic ionic liquid (IL), was applied first to the surface of the anode and then to the surface of the cathode. The polarization and power curves from the initial test and after the addition of IL to the surfaces are shown in FIGS. 9A and 9B, respectively. Application of the IL to one side of the cell increased the current nearly 30%. However, when the cell was retested 3 days later (FIGS. 9A and 9B) with IL on both electrodes, the performance returned to the initial level. The hydrophobic IL may slow water loss from the surface of the membrane and impact the diffusion of CO₂, H₂, and O₂ to the surface of the membrane. Also, the IL may trap the gases, retaining them at the surface for reaction while improving the wetting between the electrode and electrolyte.

Verification of carbonate ion transport involves consumption of carbon dioxide at the cathode, transport of carbonate ions in the membrane, and production of carbon dioxide at the anode. To verify carbonate transport and carbon dioxide consumption and production, two tests were carried out. Each of the inlets and outlets was properly sealed and/or purged to prevent atmospheric CO₂ from interfering. In the first test, hydrogen was used as the fuel and the anode exhaust was first passed through a gas trap cooled with liquid nitrogen and then bubbled through an oil bubbler to prevent air from back diffusing into the cell. The cell was operated under a 50-ohm load for approximately 10 hours (potential 0.190 V±10 mV) and a thick white solid accumulated at the bottom of the trap during the run. After completion of the run, the stopcocks at the inlet and outlet of the gas trap were closed. A tube was then connected to one side, with the other side immersed in a calcium hydroxide solution. If the precipitate were carbon dioxide, produced at the anode according to CH₃OH+3CO₃²⁻→2H₂O+4CO₂+6e⁻, calcium carbonate would precipitate. When the stopcock was opened, the solution immediately turned milky due to reaction between CaOH and CO₂. As the white solid warmed, it evaporated increasing the pressure in the gas trap. When directly injected into the gas trap, the CaOH solution became white. These tests indicate that a large amount of carbon dioxide was present in the anode exhaust during the operation of the cell, consistent with the production of CO₂ at the anode, which could only occur if carbonate/bicarbonate were the conductive ions.

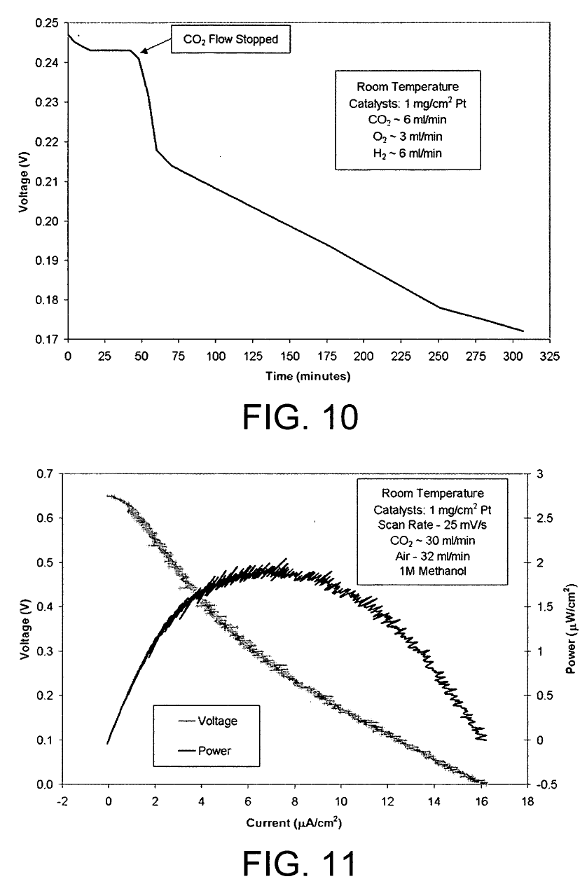

In the second test, the impact of interrupting the flow of carbon dioxide feed to the cathode was examined to see if CO₂ is consumed at the cathode. FIG. 10 shows that, immediately after the CO₂ flow was stopped, there was a substantial drop in cell voltage across the load resistor. The voltage then continued to decay more slowly over the next four hours. However, the system did not reach 0 V by the end of the test, indicating the continued presence or introduction of CO₂. The most likely source of CO₂ is permeation of CO₂ from the anode to the cathode through the membrane. As CO₂ is produced at the anode, it can cross back across the membrane to the anode. The permeation coefficient of CO₂ through a 0.5B/0.5C treated membrane was found to be 35.4 Barrier, which could account for the trickle charge measured after 5 and 6 hours. While the permeation of neutral CO₂ through the membrane from the anode to the cathode is desirable for cell operations, it does make it difficult to eliminate CO₂ from the cathode compartment for test purposes. In addition, it is difficult to completely purge and seal out all air from the cathode compartment.

While hydrogen provides an efficient method of testing the carbonate conduction mechanism, liquid fuels are of interest for atmospheric pressure operation and fuel storage. Methanol was tested as a fuel in the anionic fuel cell under a variety of conditions. FIG. 11 shows a polarization curve for 1M methanol fuel after 2 hours of operation using dry air and carbon dioxide as the cathode feed. From the current-voltage curve, the maximum power and current were about 2 μW/cm² and about 16.2 μA/cm², respectively. After 1 hour of operation, the power of the fuel cell increased to about 2.5 μW/cm² when operating with a 15 kohm load. After 24 hr, the open circuit voltage (OCV) had increased to 750 mV. Purging the cathode chamber with nitrogen for several hours resulted in the steady reduction of the cell voltage. When the oxygen flow was reestablished, the cell voltage increased rapidly as O₂ and CO₂ were available at the cathode for reduction. Cycling the CO₂ flow on and off affected the performance of the cell. For example, when operating near OCV (current <1 nA/cm²) the voltage increased more than 40 mV (from 763 to 804 mV) when the CO₂ flow was turned on. Stopping the flow would lead to a gradual decline in the voltage of the cell and not a full loss of voltage because CO₂ was also supplied from the anode side by permeation through the membrane.

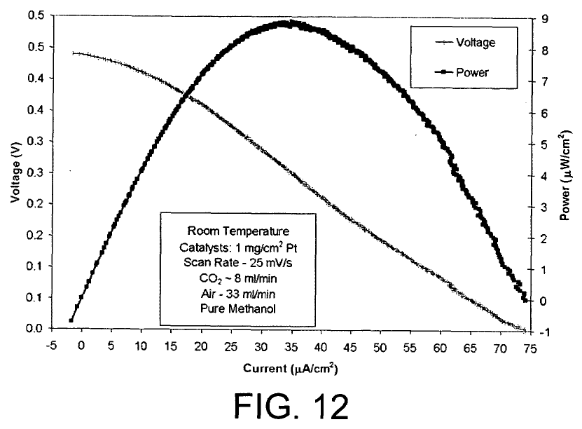

One test for an anionic fuel cell is the ability to operate with pure methanol. A proton exchange membrane requires water and methanol at the anode for oxidation to CO₂ as shown by CH₃OH+H₂O→CO₂+6H⁺+6e⁻. Measurements were taken while the cell was operated with pure methanol. The polarization curve taken after 5 hours of operation under load is shown in FIG. 12. The current under load was higher than with 1M methanol; however, OCV was less, ca. 440 mV. The maximum current, about 74 μA/cm², and power, about 8.8 μW/cm², are more than four times the values measured for the 1M methanol system. The higher current is due to the increased methanol concentration, from 1 M to 24.7 M in pure methanol. The decrease in OCV, from 750 mV to 440 mV, may be due to cross over from the anode to the cathode.

The effective diffusion coefficient of pure methanol through the 0.5B/0.5C treated membranes was evaluated by measuring the rate of transport through the membrane. A reservoir of methanol was sealed in a glass container with the membrane as the top enclosure. Based on the weight change with time, the effective diffusion coefficient was found to be 2.26 E⁻⁷ cm²/s. This value of transport is sufficient for methanol to pass through the membrane and wet the cathode electrode resulting in a lower cell voltage. In the case of 1M methanol, the concentration of methanol is only 4% of pure methanol, substantially lowering the methanol diffusion through the membrane and its effect on OCV.

### CONCLUSION

A room temperature anionic fuel cell has been constructed by modifying anion exchange membranes to transport carbonate. The cells were operated with hydrogen, 1M methanol, and pure methanol fuels using dry O₂ and CO₂ as the cathode gases. CO₂ was produced at the anode and O₂ and CO₂ were utilized at the cathode for operation, indicating that carbonate was the conducting ion.

It should be noted that ratios, concentrations, amounts, dimensions, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a range of“about 0.1% to about 5%” should be interpreted to include not only the explicitly recited range of about 0.1% to about 5%, but also include individual ranges (e.g., 1%, 2%, 3%, and 4%) and the sub-ranges (e.g., 0.5%, 1.1%, 2.2%, 3.3%, and 4.4%) within the indicated range.

It should be emphasized that the above-described embodiments of this disclosure are merely possible examples of implementations, and are set forth for a clear understanding of the principles of this disclosure. Many variations and modifications may be made to the above-described embodiments of this disclosure without departing substantially from the spirit and principles of this disclosure. All such modifications and variations are intended to be included herein within the scope of this disclosure and protected by the following claims.

Therefore, the following is claimed.

1. A fuel cell, comprising:
an anionic membrane made of a material including a carbonate conducting electrolyte;
a first catalyst layer disposed on a first side of the anionic membrane; and
a second catalyst layer disposed on a second side of the anionic membrane.

2. The fuel cell of claim 1, wherein the fuel cell is operative at a temperature from about −100° C. to +200° C.

3. The fuel cell of claim 1, wherein pure methanol is a fuel disposed on the first side of the anionic membrane, and wherein CO₂ and O₂ are disposed on the second side of the anionic membrane.

4. The fuel cell of claim 1, wherein the material of the anionic membrane is selected from at least from one of the following: carbonate salts, quaternary ammonium salts, phosphonium salts, alkali carbonates, polymer based carbonates, and combinations thereof.

5. The fuel cell of claim 1, wherein the first catalyst is selected from at least one of the following: platinum, platinum/ruthenium, aluminum, cobalt, copper, iron, lead, manganese, nickel, tellurium, titanium, alloys of each, and combinations thereof.

6. The fuel cell of claim 1, wherein the second catalyst is selected from at least one of the following: platinum, platinum/ruthenium, aluminum, cobalt, copper, iron, lead, manganese, nickel, tellurium, titanium, alloys of each, and combinations thereof.

7. The fuel cell of claim 1, wherein the first catalyst is platinum and the second catalyst is nickel.

8. The fuel cell of claim 1, further comprising a first current collector disposed on the first side of the anionic membrane and a second current collector disposed on the second side of the anionic membrane.

9. The fuel cell of claim 8, wherein the first current collector is made from at least one of the following: platinum, gold, silver, palladium, aluminum, nickel, carbon, alloys of each, and combinations thereof.

10. The fuel cell of claim 8, wherein the second current collector is made from at least one of the following: platinum, gold, silver, palladium, aluminum, nickel, carbon, alloys of each, and combinations thereof.

11. The fuel cell of claim 1, further comprising a concentrated methanol fuel having a concentration of greater than about 17 M methanol at 15° C. disposed on the first side of the anionic membrane.

12. A CO₂ pump, comprising:
an anionic membrane made of a material including a carbonate conducting electrolyte;
a first catalyst layer disposed on a first side of the anionic membrane;
a second catalyst layer disposed on a second side of the anionic membrane;
a first current collector disposed on the first side of the anionic membrane and in contact with the first catalyst layer; and
a second current collector disposed on the second side of the anionic membrane and in contact with the second catalyst layer.

13. The CO₂ pump of claim 12, further comprising a power supply, wherein the power supply is electronically connected to each of the first and second current collectors.

14. A hybrid fuel cell, comprising:
an anionic membrane made of a material including a carbonate conducting electrolyte; and
a proton exchange membrane (PEM), wherein the anionic membrane is in electrical communication with the PEM.

15. The hybrid fuel cell of claim 14, wherein the PEM comprises a material selected from organic conducting materials, inorganic conducting materials, and combinations thereof.

16. The hybrid fuel cell of claim 14, wherein the anionic membrane material is selected from at least from one of the following: carbonate salts, quaternary ammonium salts, phosphonium salts, alkali carbonates, polymer based carbonates, and combinations thereof.

17. The hybrid fuel cell of claim 14, wherein the anionic membrane and the PEM are electronically connected in at least one of the following: series, parallel and combinations thereof.

18. A method for fabricating a fuel cell, comprising:
disposing a release layer onto a molding form;
disposing a first porous catalyst layer onto the release layer;
disposing a layer of an anionic membrane material onto the first porous catalyst layer;
disposing a second porous catalyst layer onto the layer of an anionic membrane material; and
disposing a second layer of an anionic membrane material onto the second porous catalyst layer.

19. The method of claim 18, wherein the first porous catalyst layer of membrane material is about 0.1 to 500 μm thick.

20. The method of claim 18, wherein the anionic membrane material includes a carbonate conducting electrolyte.
